(19) United States
(12) Patent Application Publication
(10) Pub. No.: US 2014/0147571 A1
(43) Pub. Date: May 29, 2014

(54) Plantain Jam for Use as Topping in Pancakes and Waffles, as Sandwich Spread, as Dip and for other Apllications in Various Bakery Products

(71) Applicant: Francisco Y. Panol, Murfreesboro, TN (US)

(72) Inventor: Francisco Y. Panol, Murfreesboro, TN (US)

(21) Appl. No.: 13/685,947

(22) Filed: Nov. 27, 2012

(51) Int. Cl. A23L 1/064

(52) U.S. Cl. CPC A23L 1/064
USPC 426/573

(57) ABSTRACT

The invention, plantain jam, for use as topping in pancakes and waffles, as sandwich spread, as dip and for other applications in various bakery products is processed with ripe plantain, white refined sugar and water comprising the primary ingredients. Ripe plantains whereby about 50 to 65 percent of its skin color has turned black are selected, weighed, peeled, longitudinally cut in halves then radially sliced 1/16 to 1/8 inch thick, mixed in a cooking vat with the right proportion of ingredients then cooked for about 10 to 12 minutes from start of boil, depending on batch size, in medium heat while being slowly stirred continuously. Plantain jam is cooked when most fleece of the slices has separated from the softened core and the product appears homogenous. The jam is then packed either in glass jars, tin cans or single-use packets for distribution. There are three claims and no drawings.

### CROSS-REFERENCE TO RELATED APPLICATIONS

Not Applicable

### STATEMENT REGARDING FEDERALLY FUNDED RESEARCH OR DEVELOPMENT

Not Applicable

### REFERENCE TO SEQUENCE LISTING, A TABLE OR COMPUTER PROGRAM LISTING

Not Applicable

### BACKGROUND OF THE INVENTION

The present invention is plantain jam, a unique food product for use as topping in pancakes and waffles, as sandwich spread, as dip and other applications in various bakery products. It is manufactured using ripe plantain as the main ingredient.

Plantain, a member of genus Musa family is differentiated from the common sweet or dessert banana that is eaten raw or uncooked in its ripened state, in that plantain is almost always eaten cooked either steamed, boiled, grilled or fried commonly in green state, although in some cases it is also fried or boiled ripe. Current commercially marketed processed plantain product is chips which is fried sliced green plantain. Green and ripe plantains are also sold in many grocery stores with various ethnic groups patronizing it and which they cook in so many ways.

While there is no formal botanical distinction between the common sweet bananas and plantain and reference to either of them is based purely on how the fruits are consumed, there exist a number of distinct physical and physiological characteristics between these two groups. In general, the plantain fruits are bigger with each finger weighing 0.66 lb (300 grams) on average compared with sweet bananas such as the biggest variety like the cavendish with each finger weighing an average of only 0.46 lb (210 grams). Plantains have thicker and harder peel or skin.

Its average carbohydrates content is 32 percent, comparable with potatoes. An average plantain has about 220 calories and is a good source of potassium and dietary fiber.

Plantain has generally lower sugar content and more starch than sweet banana. Also, its moisture content of about 65 percent is lower compared with that of sweet or dessert banana of 83 percent. Since the process by which starch is converted to sugar acts faster in fruits with higher moisture content, sweet bananas ripen faster than plantain. Banana is ready to eat when the skin turns yellow while plantain is considered sufficiently ripe only when 50 to 65 percent of the skin has turned black. Sweet banana will ripen 10 to 14 days faster than plantain under the same conditions.

Plantain is considered a possible food for geriatric patients and for people suffering from gastric ulcer and in the relief of colitis owing to its low fat content as well as high fiber and starch content. More importantly, research conducted at the University of Liverpool and published in the journal Gut showed that soluble fibers found in plantain may help treat patients with Crohn's disease. Clinical trials are now ongoing to determine whether a medical food containing plantain fibers could keep Crohn's patients in remission by virtue of the cellular properties of such soluble fibers that prevent the uptake and transport of E. Coli across the so-called M-cells that act as “gatekeepers” to the lymphatic system.

Because plantain bears fruit year-round, it is a reliable all-season staple food particularly in developing countries without adequate food storage, preservation and transportation facilities. Plantain is a staple food in the tropical regions of the world particularly the Great Lakes Region in Africa covering parts of Uganda, Rwanda, Burundi, Tanzania, Kenya and Congo where per capita consumption is 250 kilograms (550 lbs) per year, the highest in the world. In Africa, plantains and bananas provide more than 25 percent of the carbohydrate requirements of over 70 million people. Likewise, plantain is an important staple food in South and Central America and the Caribbean.

Countries producing plantain specially in South and Central America and the Caribbean endeavor to enhance its economic importance by increasing consumption, particularly in lucrative export markets like North America. However, efforts along this path have been focused on improving the quality and processing of existing product lines through some improvement on the machine or processing procedure. For instance, U.S. Pat. No. 4,460,610 issued to Macfie Jul. 17, 1984 deals with impregnating ripe and peeled plantain with orange juice in order to improve flavor and texture. The impregnated plantain is then frozen and coated with antioxidant mixture of organic food acid and binder to ensure a stable raw material during transport and storage before it is processed to its final product form.

Bermejo's U.S. Pat. No. 4,740,381 issued Apr. 26, 1988 tackled the process for preparing plantain and product thereof wherein green plantain is radially sliced, the core removed, the plantain immersed in salted solution with lemon juice after the skin has been taken out of the slices, fried briefly then flattened out, frozen and packed for shipment. Removing the core from the sliced plantain is claimed to minimize transport cost and storage space requirements.

Method and apparatus for preparing sliced plantains covered by U.S. Pat. No. 6,558,725 issued to Giraldo and Juranovic pertains to improved apparatus and method for slicing and processing plantains in the preparation of a fried sliced food product. Also on the processing side, a number of banana peeling machine have been designed notably U.S. Pat. No. 4,446,782 issued to Black in 1984 and U.S. Pat. No.3,627,011 issued to Pond. Nothing in prior art developed or added a new product line that will substantially expand the consumer base for plantain.

The primary object of present invention is to add to plantain market a unique food product for use as topping in pancakes and waffles, as sandwich spread, as dip and other applications in various bakery products, that is manufactured using ripe plantain as the main ingredient. This enables a significant expansion of the consumer base for plantain that will contribute to the economic development of producing areas by increasing consumption and thereby broaden the market for plantain. And because the increased consumption will be from new consumers in North America, it will be a lucrative export market for raw or processed plantain that will greatly benefit producing areas in South and Central America and the Caribbean.

### BRIEF SUMMARY OF THE INVENTION

The present invention is plantain jam, a unique food product for use as topping in pancakes and waffles, as sandwich spread, as dip and other applications in various bakery products, that is manufactured using ripe plantain as the primary ingredient thus enabling expansion of its consumer base. Ripe plantain fruit with its skin color having changed to approximately 50 to 65 percent black is selected, weighed, peeled and cut longitudinally into halves either manually or mechanically. The halves are then manually or mechanically sliced radially approximately 1/16 to ⅛ inch thick. The slices are placed in a cooking vat or pan and mixed with the other ingredients following an approximate proportion of 0.75 cup (0.32 lb. or 145 grams) white refined sugar and 1.50 cups (12 fl. ounces or 0.75 pint) water for every pound (1.0 lb or 455 grams) of ripe unpeeled plantain. In another formulation of the plantain jam intended for calorie-conscious individuals, the refined sugar is replaced with the same amount of granulated zero-calorie sweetener. In both formulations, the amount of sweetener maybe adjusted depending on the taste preference of the target market while the addition of natural food extract such as vanilla, lemon, mango, etc., to put a desired aroma is optional.

Cooking of the mixture is carried out in medium heat. The cooking time varies slightly depending on the batch size and generally longer with bigger batches. A small batch of 5.0 lbs plantain cooks for about 10 to 12 minutes from the start of boil which is initiated in medium-high heat and subsequently lowered to medium heat once boiling starts. Continuous slow stirring is done to ensure uniformity and consistency of the product. The plantain jam is cooked when most of the fleece of every slice has separated from the softened core, completely mixed with the thickened syrup and the plantain jam appears almost homogenous. The product is then packed, under a sterile environment, either in glass jars, tin cans or single-use packets and labeled for distribution.

### DETAILED DESCRIPTION OF THE INVENTION

Because of the proximity of several plantain producing areas in the Caribbean and South and Central America to a lucrative plantain market in the United States, several countries in the region have been trying to expand the consumer base for the product. The limited range of plantain products presently available offers great opportunities for new product line and market expansion in order to have significant impact on the economy of these countries. Currently, the more widely available products patronized mostly by ethnic minorities are: a) plantain chips, a fried slices of green plantain distributed mainly in ethnic food stores, b) raw green and ripe plantain fruit found in fresh produce section of several grocery stores and c) specialty plantain food preparation offered in ethnic-regional restaurants. Diversification and expansion of plantain consumer base through the introduction of new and unique plantain product line with potentially large consumer base outside that of the current ethnic minority groups is possible. Increasing consumption particularly in the United States means more product export and foreign exchange revenue and more employment opportunities for these countries.

It was determined that plantain jam for use as topping in pancakes and waffles, as sandwich spread, as dip and for other applications in various bakery products and manufactured using ripe plantain as the main ingredient offers the greatest benefits to both the producers and consumers. It is in this context that the present invention of plantain jam was conceived.

Processing of plantain into plantain jam involves the following steps:
Selecting the plantain fruit to be processed—Sufficiently ripe plantain selected for processing are those considered to have undergone about 70 to 75 percent conversion of its starch content into sugar. This is manifested by the change in skin or peel color from yellow to about 50 to 65 percent black. Overripe plantain, i.e. with totally or 100 percent black skin and the fruit has become very soft, is avoided due to peeling and slicing difficulty and to prevent possible spread of fungus, if present, when removing the skin. Growth of fungus on the plantain skin is prevented by ripening the fruit in a low—humidity chamber having a maintained relative humidity of no more than 40 percent.
Weighing the selected plantain—Selected plantain for processing is weighed and segregated into groups according to batch size. This is done before removal of the skin for convenience in the weighing process.
Removing the skin or peeling—The skin or peel of plantain selected for processing is either mechanically or manually removed aided by traditional tool developed in plantain producing areas. Manual skin removal or peeling is preferred over the use of machine because of the irregular shape and varying sizes of the fruit.
Cutting the peeled plantain—After removing the skin, the fruit is cut or divided longitudinally into halves either mechanically or manually, although the latter is preferred. This is in preparation for the next step of slicing.
Slicing—The plantain halves are then sliced radially about 1/16 to ⅛ inch thick either manually or using a slicing machine such as the one covered by U.S. Pat. No. 6,558,725 issued to Giraldo and Juranovic or any of several slicing machine being used in the vegetable or meat industries appropriate for the purpose. With large batches, mechanically slicing the plantain halves is preferred because of speed and accuracy compared with manual slicing. The sliced plantain is then placed in the cooking vat or pan.
Mixing the ingredients—Ingredients in the manufacture of plantain jam are mixed in the cooking vat or pan. There are three ingredients in herein disclosure for the manufacture of plantain jam namely: i) sliced ripe plantain, ii) white refined sugar, and iii) water. The approximate proportion of ingredients is 0.75 cup (0.32 lb. or 145 grams) white refined sugar and 1.50 cups (12 fl. ounces or 0.75 pint) water for every pound (1.0 lb. or 455 grams) of ripe unpeeled plantain. In another formulation of the plantain jam intended for calorie-conscious individuals, the white refined sugar is replaced with the same amount of granulated zero-calorie sweetener. In both formulations, the amount of sweetener maybe adjusted depending on the taste preference of the target market while the addition of natural food extract such as vanilla, lemon, mango, etc., to put a desired aroma is optional.
Cooking the plantain jam—Cooking of the mixture is carried out in medium heat. The cooking time varies slightly depending on the batch size and generally longer with bigger batches. A small batch of 5.0 lbs. plantain cooks for about 10 to 12 minutes from the start of boil which is initiated in medium-high heat and subsequently lowered to medium heat once boiling starts. Continuous slow stirring is done to ensure uniformity and consistency of the product. The plantain jam is cooked when most of the fleece of every slice has separated from the softened core, completely mixed with the thickened syrup and the product appears almost homogenous.
Packing for distribution—Using standard equipment in the food industry, the cooked plantain jam is then packed, under a sterile environment, either in glass jars, tin cans or single-use packets and then labeled for distribution.

I claim:

1. An article of manufacture, plantain jam, for use as topping in pancakes and waffles, as sandwich spread, as dip and other applications in various bakery products, that is processed with ripe plantain, white refined sugar and water comprising the primary ingredients.

2. The process for the manufacture of plantain jam in claim 1 comprising of the following steps:
Selecting sufficiently ripe plantain whereby about 50 to 65 percent of skin color has turned black and which ripe plantain is clean and fungus-free ,
Weighing selected fruits and segregating into groups according to batch size before skin removal,
Peeling or removing skin of selected fruit either mechanically or manually,
Longitudinally cutting peeled plantain into halves and radially slicing the halves about 1/16 to 1/8 inch thick either manually or using a slicing machine,
Mixing the ingredients in cooking vat or pan following an approximate proportion of 0.75 cup (0.32 lb. or 145 grams) white refined sugar and 1.50 cups (12 fl. ounces or 0.75 pint) water for every pound (1.0 lb. or 455 grams) of ripe unpeeled plantain.
Cooking the plantain jam in medium heat for about 10 to 12 minutes after the start of boil, depending on batch size, with continuous slow stirring to ensure uniformity and consistency of the jam which is considered cooked when most of the fleece of every slice has separated from the softened core, completely mixed with the thickened syrup and the product appears almost homogenous,
Packing the cooked jam under a sterile environment either in glass jars, tin cans or single-use packets using standard canning equipment in the food industry and the product is labeled for distribution.

3. An article of manufacture, plantain jam, for use as topping in pancakes and waffles, as sandwich spread, as dip and other applications in various bakery products, intended for calorie-conscious individuals, produced with ripe plantain, granulated zero-calorie sweetener and water as the primary ingredients and processed in accordance with the following steps of:
Selecting sufficiently ripe plantain with 50 to 65 percent of skin color has turned black and which ripe plantain is clean and fungus-free,
Weighing selected fruits and segregating into groups according to batch size before skin removal,
Peeling or removing skin of selected fruit either mechanically or manually,
Longitudinally cutting peeled plantain into halves and radially slicing the halves about 1/16 to ⅛ inch thick either manually or using a slicing machine,
Mixing the ingredients in cooking vat or pan following an approximate proportion of 0.75 cup (0.32 lb. or 145 grams) granulated zero-calorie sweetener and 1.50 cups (12 fl. ounces or 0.75 pint) water for every pound (1.0 lb. or 455 grams) of ripe unpeeled plantain,
Cooking the plantain jam in medium heat for about 10 to 12 minutes after the start of boil, depending on batch size, with continuous slow stirring to ensure uniformity and consistency of the jam which is considered cooked when most of the fleece of every slice has separated from the softened core, completely mixed with the thickened syrup and the product appears almost homogenous,
Packing the cooked jam under a sterile environment either in glass jars, tin cans or single-use packets using standard canning equipment in the food industry and the product is labeled for distribution.
